(19) United States
(12) Patent Application Publication
(10) Pub. No.: US 2013/0148582 A1
(43) Pub. Date: Jun. 13, 2013

(54) MESSAGE INJECTION SYSTEM AND METHOD

(71) Applicant: TIP Solutions, Inc., Chicago, IL (US)

(72) Inventors: John T. Braun, Vernon Hills, IL (US); Daniel P. Quigley, Woodinville, WA (US); Timothy M. Nitsch, LaGrange, IL (US); Michael Unetich, Chicago, IL (US)

(73) Assignee: TIP Solutions, Inc., Chicago, IL (US)

(21) Appl. No.: 13/761,994

(22) Filed: Feb. 7, 2013

Related U.S. Application Data
(63) Continuation-in-part of application No. 13/347,476, filed on Jan. 10, 2012.
Application No. 13/347,476 is a continuation-in-part of application No. 13/298,961, filed on Nov. 17, 2011.

(51) Int. Cl. H04W 92/02

(52) U.S. Cl. CPC H04W 92/02
USPC 370/328

(57) ABSTRACT

A communication bridging device has a processor and a memory. The communication device includes an application unit operating an application that transmits and receives communication signals to a first communication device over a first wireless network, a wireless interface unit that transmits and receives communication signals to a second communication device over a second wireless network, and a switching unit communicatively coupled to the application unit and the wireless interface unit. The switching unit transmits communication signals between the first network and the second network in a bridging mode. The application unit transmits communication signals from the switching unit to the first communication device over the first wireless network in the bridging mode, and the wireless interface unit transmits communication signals from the switching unit to the second communication device over the second wireless network in the bridging mode.

### CROSS-REFERENCE TO RELATED APPLICATIONS

This application is a continuation in part application of U.S. patent application Ser. No. 13/347,476 filed Jan. 10, 2012, which is a continuation in part of U.S. patent application Ser. No. 13/298,961, filed Nov. 17, 2011, which is incorporated by reference herein in its entirety.

### BACKGROUND

The present disclosure, is directed to a device and method for bridging, an audio stream from a Voice Over Internet Protocol to a mobile communication device such as a cellular phone.

Devices capable of sending and receiving communications, such as phone calls, text messages, electronic mail, instant messaging requests, and other electronic updates and information are becoming increasingly prevalent. Such devices come in a wide variety and may be generally stationary, such as a desktop computer, TV/Set-Top box, static game console, etc., or may be easily portable, such as a smart phone, tablet computer, notebook computer, personal digital assistant (“PDA”), portable game console, portable media device, and the like. Further, such devices may send and receive communications through a wide variety of wired or wireless connections, standards, or protocols, such as the Internet, an intranet, voice over interne protocol (“VOIP”), satellite, 3G, SMS, MMS, 4G, WIMAX, etc.

Many times, a user of a cellular device may initiate a call while commuting to an office or to a location having a wired communication device, such as a VOIP phone. Even with current cellular technology, speaking on a cellular phone can cause many problems with reception and clarity. Further, in buildings and other locations where cellular signals do not propagate well, another wireless or wired technology may be more suitable for communication. However, using current technology, there is no method of seamlessly bridging between a cellular call and a VOIP call without disconnecting a call and redialing.

### SUMMARY

Various embodiments of the present disclosure include a communication bridging device having a processor and a memory, the communication device including an application unit operating an application that transmits and receives communication signals to a first communication device over a first wireless network, a wireless interface unit that transmits and receives communication signals to a second communication device over a second wireless network, a switching unit communicatively coupled to the application unit and the wireless interface unit. The switching unit transmits communication signals between the first network and the second network in a bridging mode, the application unit transmits communication signals from the switching unit to the first communication device over the first wireless network in the bridging mode, and the wireless interface unit transmits communication signals from the switching unit to the second communication device over the second wireless network in the bridging mode.

In another embodiment, the first wireless network is the internet and the second wireless network is a cellular network.

Another embodiment includes a display unit coupled to an input output unit in the bridging device.

In another embodiment, an operational mode is adjusted by a graphical user interface shown on the display.

In another embodiment, the communication signal is an audio signal.

In another embodiment, the communication signal is a text message.

In another embodiment, the communication signal is a data signal.

The first communication device is a voice over internet protocol phone and the second communication device is a cellular phone.

In another embodiment, the application simultaneously transmits and receives communication signals for the first communication device and a fourth communication device communicatively coupled to the first wireless network.

Another embodiment includes a method of bridging a communication signal across two networks using a communication device having a memory and a processor. A program executing in the memory executes the steps of connecting to a first communication device over a first network by an application unit, connecting, simultaneously, to a second communication device over a second network by a wireless interface unit, receiving a first communication signal from the first communication device by the application unit, transmitting the first communication signal from the first device to the second network by a switching unit coupled to the application unit and the wireless interface unit.

In another embodiment, the program may also perform the steps of receiving a second communication signal from the second communication device, and transmitting the second communication signal from the second communication device to the first communication device by the switching unit.

In another embodiment, the first wireless network is the interact and the second wireless network is a cellular network.

In another embodiment, the method may include the step of displaying a graphical user interface on a display unit coupled to an input output unit in the device, where the graphical user interface allows a user to change an operational mode of the device.

In another embodiment, the communication signal is an audio signal.

In another embodiment, the communication signal is a text message.

In another embodiment, the communication signal is a data signal.

In another embodiment, the first communication device is a voice over internet protocol phone and the second communication device is a cellular phone.

In another embodiment the program also performs the step of simultaneously transmitting and receiving communication signals for the first communication device and a fourth communication device communicatively coupled to the first wireless network.

Another embodiment includes a wireless communication device having a memory and a processor. The device includes a wireless interface unit simultaneously connected to a radio communication unit in a first communication device by a first wireless network and to an application unit in the first communication device by a second wireless network, and an application unit, communicatively coupled to the first network and second network by the wireless interface unit. The application unit receives a first communication signal from a radio application unit in the first communication device over the first network and transmits the communication signal to the application unit by the second network, and the application unit transmits the first communication signal to a second communication device by a third wireless network coupled to the first communication device.

In another embodiment, the application unit receives a second communication signal from an application processing unit in the first communication device, and the application unit transmits the second communication signal to the radio application unit in the first communication device via the first network.

Another embodiment includes a speaker and a microphone communicatively coupled to the application unit.

These and other features and advantages of the present disclosure will be apparent from the following detailed description, in conjunction with the appended claims.

### BRIEF DESCRIPTION OF THE DRAWINGS

Details of the present disclosure, including non-limiting benefits and advantages, will become more readily apparent to those of ordinary skill in the relevant art after reviewing, the following detailed description and accompanying drawings, wherein:

FIG. 1 illustrates a schematic representation of a mobile communication device;

FIG. 2 illustrates a schematic representation of the interaction between an application processing unit and radio communication unit in the mobile communication device of FIG. 1;

FIG. 3A illustrates a schematic representation of an audio switch unit in the mobile communication device of FIG. 1;

FIG. 3B illustrates a schematic representation of the audio switch unit of FIG. 3A when a telephone call is active;

FIG. 4 depicts an illustrative example of the mobile communication device of FIG. 1 transmitting an audio signal to a speaker on the mobile communication device;

FIG. 5A depicts the audio switch unit in the mobile communication device of FIG. 1 with an audio path opened between the application audio unit and radio audio unit;

FIG. 5B depicts a schematic representation of a process used to transmit a prerecorded audio file over a wireless network via the radio interface unit in the mobile communication device of FIG. 1;

FIG. 5C illustrates a schematic representation of a process used to transmit an analog signal from an application in the mobile communication device of FIG. 1 to the wireless network when a call is received by the mobile communication device of FIG. 1;

FIG. 5D illustrates a schematic representation of the mobile communication device of FIG. 1 that is capable of transmitting video over a wireless network;

FIG. 6A illustrates a configuration of the audio switch unit in the mobile communication device of FIG. 1;

FIG. 6B illustrates a schematic representation of a process to transmit an audio signal from the mobile communication device of FIG. 1 over a wireless network;

FIG. 7A illustrates a schematic representation of the mobile communication device of FIG. 1 connected to an external device that transmits a prerecorded audio signal over a wireless network;

FIG. 7B illustrates a schematic representation of a process to transmit an audio signal from an external device over a wireless network through the mobile communication device of FIG. 1;

FIG. 8A depicts an external device that is configured to transmit an audio signal over a wireless network;

FIG. 8B depicts a connection unit for the external device;

FIG. 9A illustrates a schematic representation of a cellular network communicating with a VOIP network;

FIG. 9B illustrates a schematic representation of the second communication device of FIG. 9A;

FIG. 9C depicts a schematic illustration of the software operating on the second communication device of FIG. 9B;

FIG. 10 illustrates the audio switch unit with an audio path opened between the application audio unit and radio audio unit;

FIG. 11 depicts the audio switch unit with an path opened between the application audio unit, and radio audio unit, and the path opened between the application audio unit and a WiFi communication unit;

FIG. 12 illustrates a method of bridging a communication connection from a first network to a second network using the mobile communication device of FIG. 1;

FIG. 13A illustrates a graphical user interface displayed on the display of the mobile communication device of FIG. 1;

FIG. 13B illustrates a graphical user interface that is displayed on the mobile communication device of FIG. 1 after a user selects the button of FIG. 13A; and

FIG. 14 depicts an external device that may be used to bridge calls on a communication device.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to be limited to any specific embodiment disclosed herein.

The present disclosure is directed to one or more communication devices capable of transmitting an audio signal over a wireless network, such as a cellular network, to a second device. The transmission of the audio signal may be part of a larger communication management system which is used to notify callers that the user of the mobile communication device is unavailable. The audio signal may be sent as a single transmission, or may be appended to another audio signal that was received in real time. The term audio is being used herein for illustrative purposes and may be interpreted to mean an audio signal, video signal, data signal, or any other communication signal that is transmitted on a mobile communication device.

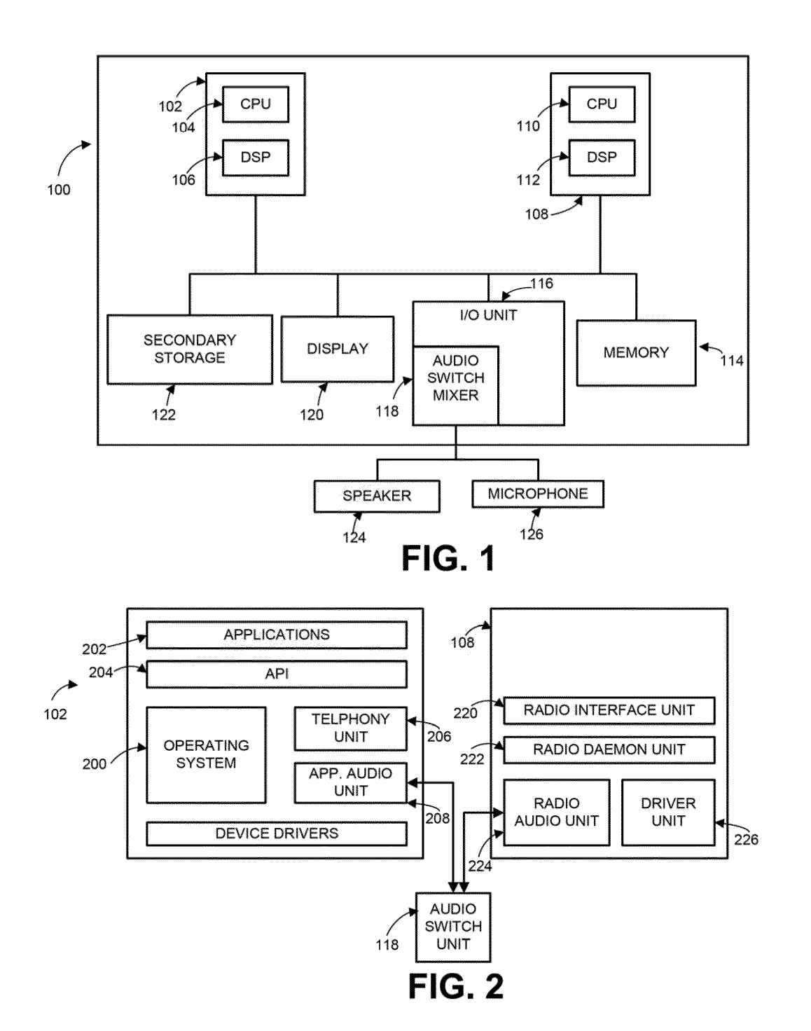

FIG. 1 illustrates a mobile communication device 100. The mobile communication device 100 includes an application processing unit 102 that includes a central processing unit (CPU) 104 and a digital signal processor (DSP) 106, a radio communication unit 108 that includes a CPU 110 and DSP 112, a memory 114, an input output (10) unit 116 that includes an audio switch unit 118, a display 120, and a secondary storage unit 122.

The radio communication unit 108 is configured to communicate across a wireless network. The radio communication unit 108 may be configured to communicate over a wireless cellular network using any cellular protocol including, but not limited to, code division multiple access (CDMA), global system for mobile communications (GSM), and universal mobile telecommunications system (UMTS), Short Message Service (SMS), Multimedia Messaging Service (MMS), Long Term Evolution (LTE) or any other cellular communication protocol. The radio communication unit may also communicate over different networks including satellite networks, 3G cellular networks, 4G cellular networks, WIMAX networks, or any other network.

The IO Unit 116 is coupled to a speaker 124 and a microphone 126 via the audio switch unit 118. The audio switch unit 118 is configured to receive an audio signal from the microphone 126, and to adjust various characteristics of the received audio signal. The audio switch unit 118 may adjust the volume of the audio, side tone generation, comfort noise generation, echo cancellation, automatic gain, noise suppression, tone generation, or any other characteristic of the audio signal. The audio switch unit 118 also routes audio signals received by the microphone 126 to the application processing unit 102, or the radio communication unit 108, and also routes audio from the application processing unit 102 and radio communication unit 108 to the speaker 124. The audio switch unit 118 may also be configured to transmit video signals, data signals, or any other communication signal transmitted through a mobile.

FIG. 2 is a schematic representation of the interaction between the application processing unit 102 and radio communication unit 108. The application processing unit 102 includes an operating system 200 running in the CPU 104 of the application processing unit 102. The operating system 200 may be any commercially available operating system including Linux, Windows Mobile, Google Android, or any other operating system capable of running on a mobile device. The operating system 200 controls the operation of the CPU 104 and DSP 106 in the application processing, unit 102. An application 202 operating in the operating system 200 interacts with different components of the mobile device 100, such as the display 120, speaker 124, and microphone 126, via an application programming interface (API) 204.

The radio communication unit 108 includes a radio interface unit 220, a radio daemon unit 222, a radio audio unit 224, and a driver unit 226 operating via the CPU 110 and DSP 112. The radio audio unit 224 is communicatively coupled to the audio switch unit 118, such that the audio switch unit 118 transmits audio captured by the microphone 126 for transmission over the wireless network by radio hardware coupled to the driver unit 226. The radio audio unit 224 also transmits audio information received from the radio hardware via the driver unit 226 to the speaker 126 via the audio switch unit 118.

The radio interface unit 220 performs high level operations to initiate a connection between the mobile device 100 and another device connected to the wireless network via the driver unit 226. The radio interface unit 220 is also communicatively coupled to a telephony unit 206 in the application processing unit 102. As an illustrative example, the radio interface unit 220 may receive a command from the telephony unit 206 to initiate a phone call between two mobile devices. The radio interface unit 220 communicates with the radio audio unit 224 and driver writ 226, via the radio daemon unit 222, to connect to the wireless network and initiate a call between the two devices. The radio interface unit 220 also communicates with the telephony unit 206 to notify the telephony writ 206 that a phone call has been initiated either by the mobile device 100 or by an external device that is calling the mobile device 100. The telephony unit 206 communicates with the application 202 running in the application processing unit 102 to provide a status of the radio transmission unit 208, and to initiate actions in the radio transmission unit 108.

The radio audio unit 224 in the radio communication unit 108 is communicatively coupled to the audio switch unit 118, such that the radio audio unit 224 instructs the audio switch unit 118 to send audio signals from the microphone 126 to the radio audio unit 224, and to transmit audio signals from radio audio unit 224 to the speaker 124 via the audio switch unit 118. The hardware driver unit 226 is communicatively coupled to the radio hardware in the mobile device 100 such that the hardware driver unit 226 initiates a connection with a wireless network, via the radio hardware, and controls the transmission and receipt of audio signals onto and from the wireless network. The hardware driver unit 226 is communicatively coupled to the radio audio unit 224 via the radio interface unit 220 and the radio daemon unit 222, such that the radio audio unit 224 provides audio signals from the microphone 124 to the hardware driver unit 226 for transmission over the wireless network. The hardware driver unit 226 also transmits audio signals received from the wireless network to the radio audio unit 224 for transmission to the speaker 124.

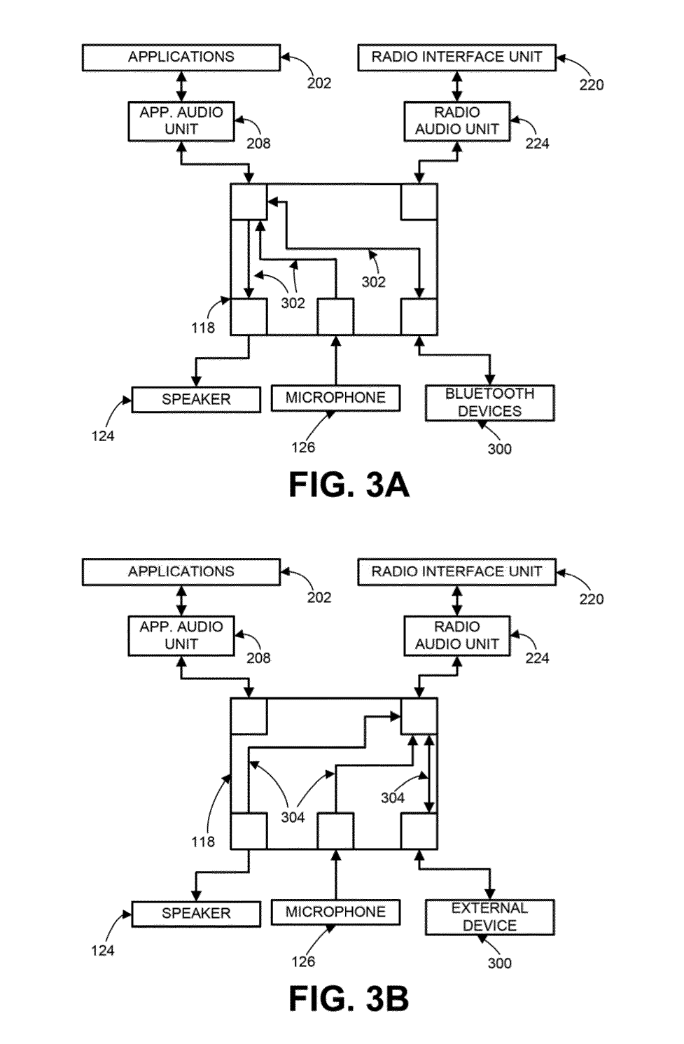

FIG. 3A is a schematic representation of the audio switch unit 118 transmitting audio to the speaker 124 and/or microphone 126. The audio switch unit 118 is communicatively coupled to the speaker 124, the microphone 126, and an external device 300. The audio switch unit 118 receives a signal from the application 202, via the application audio unit 208, requesting the creation of an audio path 302 between the speaker 124, microphone 126 or external device 300. Upon receiving the request, the audio switch unit 118 creates an audio path 302 between the requested devices and the application audio unit 208. The application audio unit 208 applies the appropriate filters to the audio signal sent to, or received front, the audio switch unit 118, and routes the audio signal to the audio switch unit 118. The application 202 transmits audio signals to the speaker 124, or external device 300, via the audio path 302, and receives audio signals from the microphone 126, or external device 300, via the audio path. The audio signals may be in any format used to store audio including, but not limited to MP3, MPEG, WAY or any other digital audio format. The application audio unit 208 may convert the audio signals to analog audio signals before transmitting the analog audio signals to the audio switch unit 118.

FIG. 3B is a schematic representation of the audio switch unit 118 when the radio transmission unit 108 is managing a call between the mobile communication device 100 and another device via a wireless network. When the audio switch unit 118 receives a signal from the radio interface unit 220, via the radio audio unit 224, to open an audio path 304 between the radio interface unit 220, the speaker 124, microphone 126, or the external device 300, the audio switch unit 118 closes all open audio paths, and opens audio paths 304 between the radio interface unit 220 and the speaker 124 and between the radio interface unit and the microphone 126, or between the radio interface unit 220 and the external device 300. The radio audio unit 224 includes all necessary filters required to prepare the audio signal received from the microphone 126 for transmission over the wireless network via, the radio interface unit 220 and the driver unit 226.

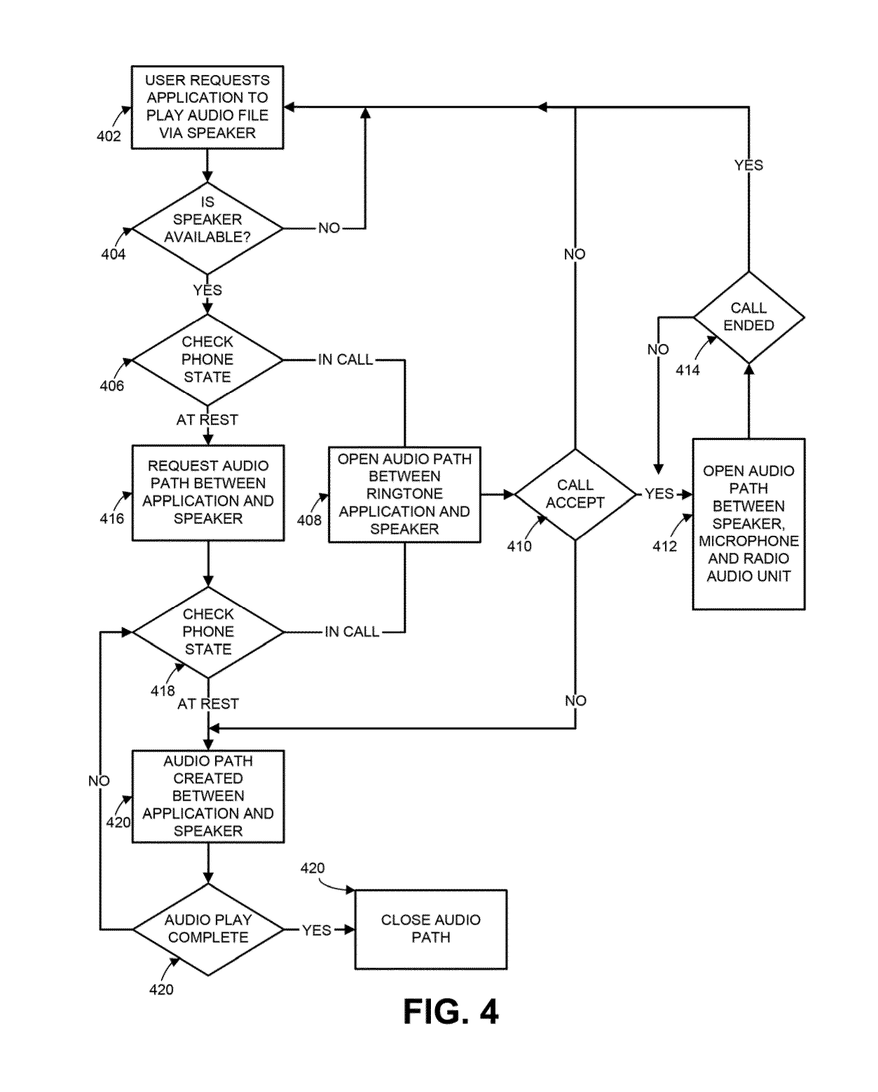

FIG. 4 depicts an illustrative example of a mobile communication device 100 transmitting an audio signal to the speaker 124. In step 402, a user requests an application 202 transmit an audio signal to the speaker 124. The application 202, in step 404, requests the status of the speaker 124 from the audio switch unit 118. If an audio path is open between the speaker 124 and the radio interface unit 220, the application 202 waits for the speaker 124 to become available. If the speaker 124 is available, the application 202 requests the status of the radio interface unit 220, via telephony unit 206, at step 406. The radio interface unit 220 returns a status of “IN CALL” indicating a telephone call is incoming, or “AT REST” indicating that the radio interface unit 220 is not currently receiving a telephone call.

If the radio interface unit 220 returns a status of “IN CALL,” the application 202 directs the audio switch unit 118 to open an audio path 302 between the application 202 and the speaker 124 to transmit a preassigned ringtone audio signal, via the application audio unit 208, to the speaker 124 in step 408. The audio switch unit 118 closes any open audio connections to the speaker 124, and opens an audio path 302 between the application 202 and the speaker to transmit the pre-assigned audio signal to the speaker 124. While the ringtone audio signal is being transmitted to the speaker 124, the telephony unit 206 requests the caller information from the radio interface unit 220, which is passed to the application 202 for display to a user via the display 120 of the mobile device 100. The application 202 also presents buttons on the display 120 that ask the user if they would like to accept or decline the incoming call.

If the user accepts the call, via the buttons displayed by the application 202 on the display 120, the telephony unit 206 sends a signal to the radio interface unit 220 to initiate the call in step 410. The radio interface unit 220 initiates a connection to the wireless network via the driver unit 226, and instructs the audio switch unit 118 to open audio paths 304 between the radio interface unit 220, the speaker 124, and microphone 126. The audio switch unit 118 closes the audio path 302 between the application 202 and the speaker 124, and opens the audio path 304 between the speaker 124, microphone 126, and the radio interface unit 220 via the radio audio unit 224. Upon termination of the audio path 302 to the application 202, transmission of the ringtone audio signal by the application 202 is terminated. In step 414, the radio interface unit 220 waits for the call to terminate before sending a signal to the telephony unit 206 that the call has ended. Once the call has ended the application 202 returns to step 402, and the audio switch unit 118 closes the audio path 304 between the radio interface unit 220, the speaker 124, and the microphone 126.

In step 416, if the radio interface unit 220 returns an indication that the phone is “AT REST,” the application 202 opens an audio path 302 between the application 202 and the speaker 124 via the application audio unit 208 and the audio switch unit 118. In step 418, the application 202 checks the status of the radio interface unit 220, via the telephony unit 206, to confirm the radio interface unit 220 is not receiving a telephone call. While the audio signal is transmitted to the speaker 124, the application 202 checks the status of the radio interface unit 220 via the telephony unit 206. If the radio interface unit 220 is still “AT REST,” the application 202 transmits the audio signal to the speaker 124 via the application audio unit 208 and the audio switch unit 118, in step 420. If the radio interface unit 220 transmits an “IN CALL” flag to the telephony unit 206, the transmission of the audio signal to the speaker 124 stops, and the process moves to step 408. In step 422, the application 202 keeps the audio path 302 open while the audio signal is transmitted to the speaker 124 and the radio interface unit 220 remains at rest, and closes the audio path 302, in step 424, when the audio signal transmission is complete.

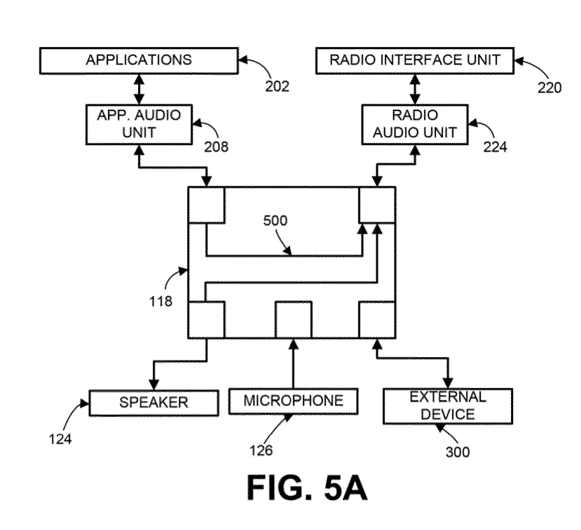

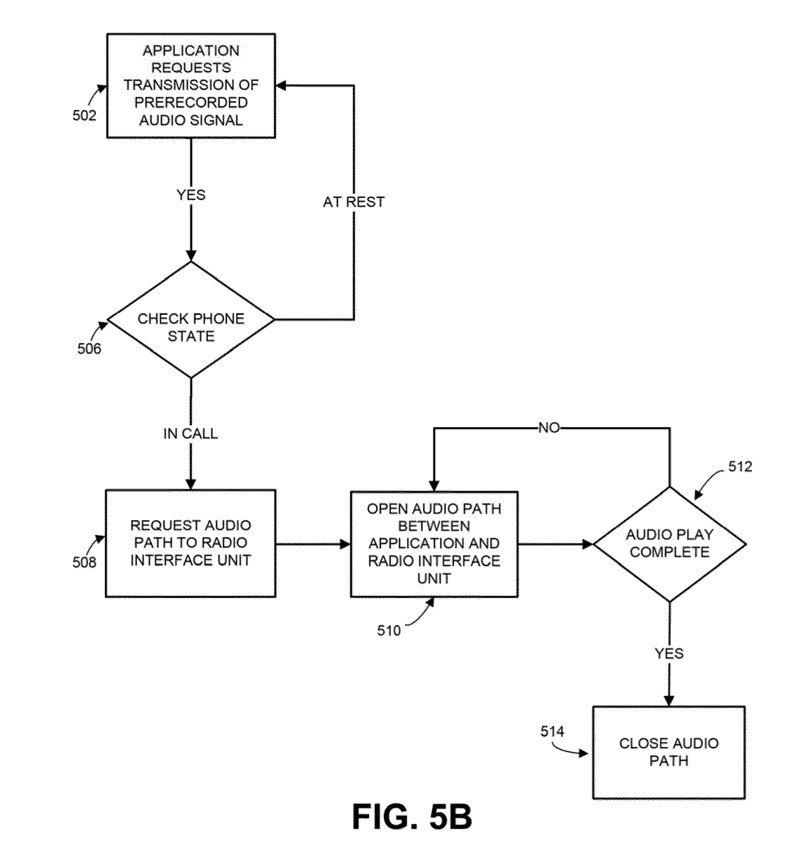

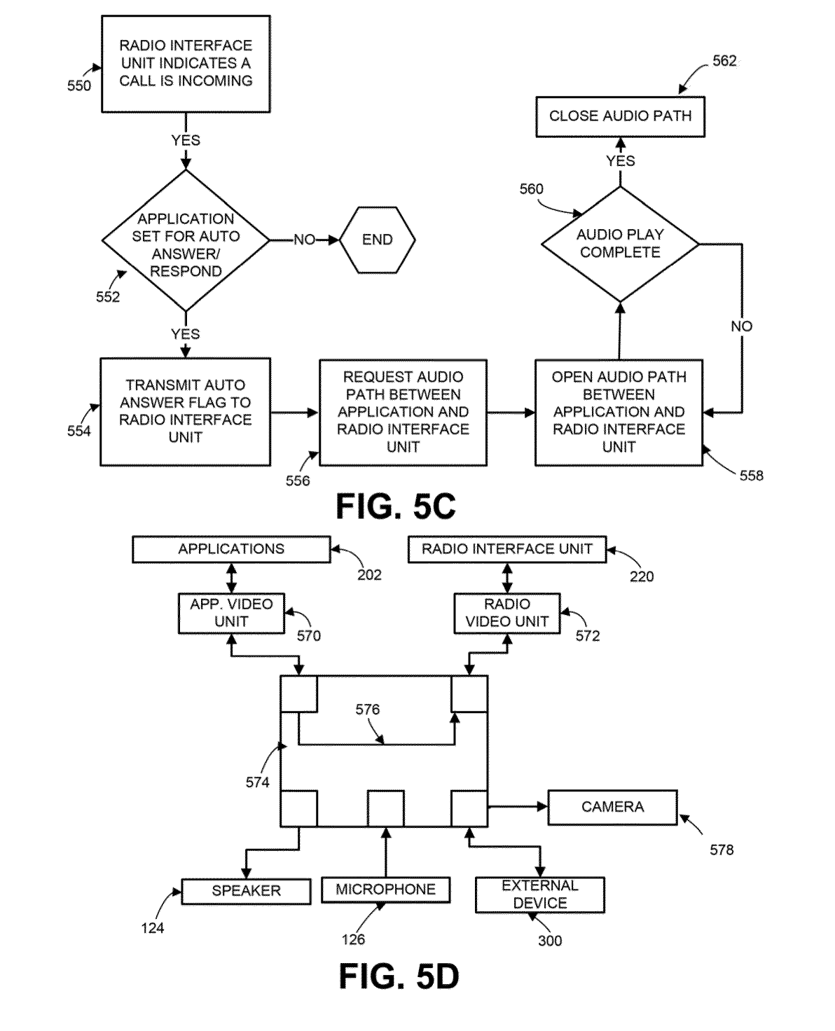

FIG. 5A depicts the audio switch unit 118 with an audio path 500 opened between the application audio unit 208 and radio audio unit 224. This configuration allows for an application 202 to send a pre-recorded audio signal to the radio interface unit 220 for transmission across the wireless network. FIG. 5B depicts a schematic representation of the process used to transmit a prerecorded audio signal over a wireless network via the radio interface unit 220. In step 502, the application 202 requests the transmission of a prerecorded audio signal over the wireless network via the radio interface unit 220. In step 504, the application 202 checks the status of the radio interface unit 220 via the telephony unit 206, lithe radio interface unit 220 returns an “AT REST” status, the application 220 returns to step 502 to wait for a call to be initiated. If the radio interface unit 220 returns an “IN CALL” status, the application 202 requests the audio path 500 be opened between the radio interface unit 220 and the application 202 in step 508. The application may also initiate a call to another device via the telephony unit 206, by sending an “INITIATE CALL” flag, to the radio interface unit 226.

In step 510, the audio switch unit 118 opens an audio path 500 between the application 202 and the radio interface unit 220, by first closing the audio path 304 between the radio interface unit 220 and the microphone 126, and opening the path between the application 202 and the radio interface unit 220 via the application audio unit 208 and the radio audio unit 224. In step 512, the application 202 transmits the audio signal through the audio path 500 via the application audio unit 208. The radio audio unit 224 receives the audio signal from the application audio unit 208, and passes the audio signal through a plurality of filters that prepare the audio signal for transmission over the wireless network, via the hardware driver unit 226. After the audio signal transmission is complete, the audio switch unit 118 may close the audio path 500. The application 202 may also keep the audio path 500 open until the radio interface unit 220 indicates that the call is terminated. If the audio path 500 remains open while the call is active, audio received from the wireless network may be sent to the application 202 where it may be saved in the memory 114, or the secondary storage unit 122, of the mobile communications device 100.

FIG. 5C is a schematic representation of the process used to transmit an analog signal from an application 202 to the wireless network when a call is received. In step 550, the application 202 receives an indication from the radio interface unit 220 that a call is incoming. The radio interface unit 220 may transmit an “IN CALL” flag to the application 202 via the telephony unit 206. The radio interface unit 220 may also transmit information on the call such as, but not limited to caller identification information, caller location, or any other information related to the call to the application 202 via the telephony unit 206. In step 552, the application 202 confirms it is configured to auto answer an incoming call. The application 202 may use the caller information transmitted by the radio transmission unit 220 to determine if the call is to be auto answered. As an illustrative example, the application 202 may only answer calls from callers on a predefined caller list that is stored in the memory 114 of the device 100. The application 202 may also ignore calls from users on the caller list. The application 202 may also prompt a user of the mobile communication device 100 whether to answer the call by displaying a message on the display 120. If the application is not configured for auto answer, the application 202 ends. If the application 202 is configured to auto answer a call, the telephony unit 206 transmits an “AUTO ANSWER” flag to the radio interface unit 220.

In step 554, the radio interface unit 220, receives the “AUTO ANSWER” flag and does not request an audio path between the speaker 124, the microphone 126, or the external device 300. In step 556, the application 202 requests an audio path 500 between the application and the radio interface unit 220 via the application audio unit 208. In step 558, the audio switch unit 118 opens the audio path 500, and the radio interface unit 220 initiates the call over the opened audio path 500. The application 202 transmits the audio signal over the audio path 500 through the application audio unit 208 and the radio audio unit 224 after the radio interface unit 220 confirms the call is initiated via the telephony unit 206, and the driver unit 226 receives the audio signal from the radio interface unit 220, via the radio audio unit 224, and transmits the audio signal over the wireless network.

In step 560, the application 202 determines if the audio signal has completely transmitted over the audio path 500. If the audio signal has completely transmitted, the application 202 may request the audio path 500 be closed. The application 202 may also terminate the call by transmitting an “END CALL” flag from the telephony unit 206 to the radio interface unit 220. The application 202 may also maintain the audio path 500 until the user of the mobile device 100 receives the call by pressing a button displayed by the application 202 on the display 120 of the mobile communication device 100. If the user indicates that they would like to receive the call, the application 202 transmits an “IN CALL” flag to the radio interface unit 220, which requests the audio switch unit 118 close audio path 500 and open audio path 304.

The application 202 may analyze information from additional sources, such as a schedule application residing in, or external to, the mobile communication device 100, global positioning satellite (GPS) information, or any other user specific information to determine if the “AUTO ANSWER” flag should be turned on. As an illustrative example, the application 202 may query a scheduling application on the mobile communication device 100 to determine if the “AUTO ANSWER” flag should be turned on. The application 202 may transmit the “AUTO ANSWER” flag to the radio interface unit 220 when a user receives a call when they are in a scheduled event. To determine if the user is in a scheduled event, the application 202 may compare the current time and date to a starting and ending time and date in the user's schedule to determine if the event is in progress. If the event is in progress, the application will send the “AUTO ANSWER” flag to the radio interface unit when a call is in coming.

The user may also supply a listing of authorized phone numbers that should not be auto answered during the event. As another illustrative example, a user may designate a specific phone number to pass through to the phone during the event such as a family member, or a client, calling the user. When the indicated phone number is transferred to the telephony unit 206 from the radio interface unit 220, as part of the call information, the application 202 will transmit an “ACCEPT CALL” signal to the radio interface unit 220 instructing the radio interface unit 220 to open the audio path to the speaker 124 and microphone 126. The application 202 will not open an audio path between the radio interface unit 220 and the speaker 124 if the caller information is not in the list of authorized phone numbers.

The application 202 may also look to multiple pieces of information to determine if the “AUTO ANSWER” flag should be transmitted to the radio interface unit 220. As an illustrative example, the application 202 may analyze the schedule information and the GPS position of the user to determine if the user is at the location of the meeting. If the user is at the location of the meeting, the “AUTO ANSWER” flag is transmitted to the radio interface unit 220 when a call is incoming. If the user is not at the location indicated by the schedule information the “AUTO ANSWER” is not transmitted.

The application 202 may also automatically open an audio path 304 from the radio audio unit 224 to the speaker 124 when a call from a specific device is received. As an illustrative example, the application 202 may receive caller information, and an “IN CALL” flag, from the radio interface unit 220 via the telephony unit 206. The application 202 may compare the received caller information, such as the phone number of the device calling in, to an authorized list of phone numbers stored in the memory of the mobile communication device 100, and may automatically accept the call and open an audio path to the speaker 124 and microphone 126 when the caller information matches a predefined caller stored in authorized list. Since the audio channel is open on both devices an intercom affect is achieved where both panics can communicate with one another over the wireless network.

FIG. 5D is a schematic representation of a mobile device capable of transmitting video over a wireless network. Consistent with this embodiment, the mobile communication device 100 includes a video switching unit 574, an application video unit 570, and a video radio unit 572. The video switch unit 574 is configured to receive a video signal from the application 202, via the application video unit 570, and to transfer the video signal to the radio video unit 572 via the video signal path 576. The application video unit 570 is also configured to format the video signal into a format operable with the radio video unit 572. The radio video unit 572 may also include a plurality of filters to format the video signal for transmission over the wireless network by the hardware driver 226. The mobile communication device 100 may simultaneously transmit video and audio signals over the wireless network via the hardware driver 226. The transmission of the video signal may be initiated by any of the means previously discussed, such as, the receipt of a phone call from an authorized phone number. The video signal may be generated by a camera 578 optically coupled to the application processing unit 102 via the IO unit 116. The camera 578 can be used to record, or generate, the video signal that is transmitted over the wireless network.

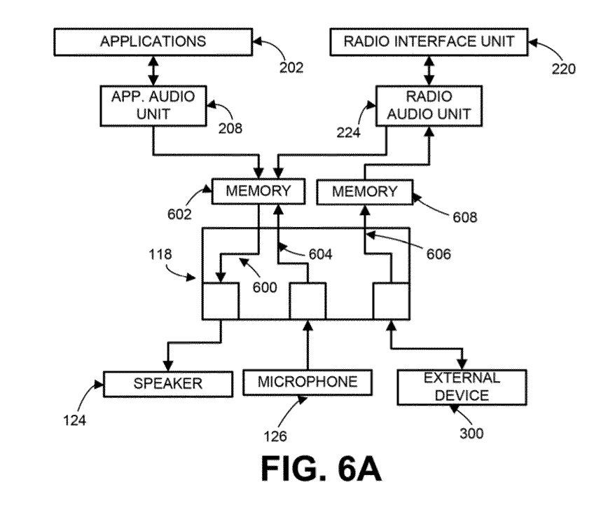

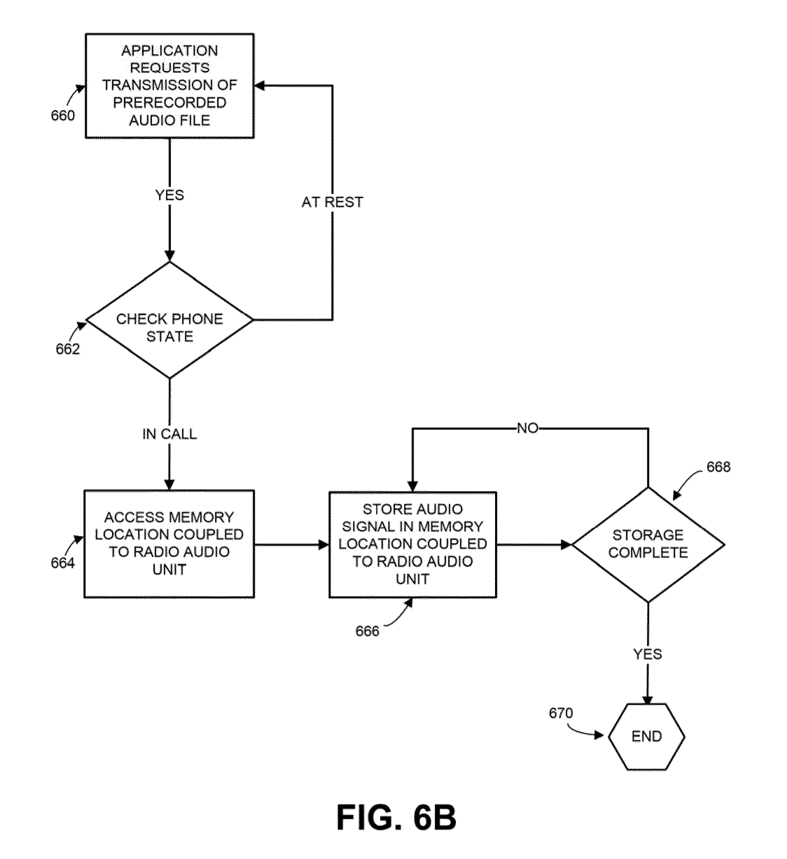

FIG. 6A depicts a configuration of the audio switch unit 118. The audio switch unit 118 is coupled to the speaker 124, microphone 126, application audio unit 208, and radio audio unit 224. The audio framework 206 and the radio audio unit 224 are coupled to the audio switch unit 118 via memory locations 602 and 606. The memory locations 602 and 606 may be partitions of the memory 114, or partitions of the secondary storage unit 122. Further, each memory location 602 and 606 may be partitioned into multiple memory locations.

The radio audio unit 224 stores audio signals received from the driver unit 226 in the memory 602, and the audio switch unit 118 extracts the stored audio form the memory location 602, and transmits the audio signal to the speaker 124 via the audio path 600. The audio switch unit 118 receives audio from the microphone 126, and stores the audio from the microphone 126 in the memory location 602 via audio path 604. The radio audio unit 224 extracts the audio signal from the memory location 602, and transmits the audio signal to the wireless network via the radio interface unit 220 and the driver unit 226. The radio audio unit 224 also stores audio signals received from the wireless network in memory location 602. Similarly, the external device 300 transmits and extracts audio signals from the memory 608 via audio path 606. The application audio unit 208 is also coupled to the memory location 602, and is configured to read and write audio signals into the memory location 602.

FIG. 6B depicts a schematic representation of a process to transmit an audio signal over a wireless network. In step 660, the application 202 requests transmission of an audio signal. In step 662, the application 202 checks the status of the radio interface unit 220 via the telephony unit 206. If the radio interface unit 220 returns an “AT REST” status, the application 202 waits for the status to change to an “IN CALL” status. The application 202 may also initiate a call by transmitting a INITIATE CALL″ flag to the radio interface unit 220 via the telephony unit 206. If the application 220 initiates the call, the radio interface unit 220 connects to the wireless network, via the driver unit 226, and performs all required functions to initiate the call over the wireless network. When the intended mobile device accepts the call, the radio interface unit 220 sends an “IN CALL” flag to the telephony unit 206, which forwards the “IN CALL” status to the application 202.

In step 664, the application 202 access the memory location 602 where audio transmitted to the wireless network is stored via the application audio unit 208. The application 202 may transmit a “VIRTUAL CALL” flag to the audio switch unit 118, which causes the audio switch unit 118 to close the audio path 604 between the microphone 126 and the memory location 602. The application 202 may also connect to the microphone 126 and prevent the microphone 126 from transmitting an audio signal to the memory 602.

In step 666, the application 202 routes the audio signal through the application audio unit 208, which formats the audio signal into a format compatible with the radio audio unit 224, and then stores the converted audio signal in the memory 602. The radio audio unit 224 extracts the audio signal from the memory location 602, and transmits the audio signal over the wireless network via the radio interface unit 220 and the driver unit 226. In step 668, the application audio unit 208 determines if the audio signal has been successfully stored in the memory location 602. If the storage is successful, the application 202 ends the process. If the storage is not successful, the application 202 attempts to store the audio signal a second time.

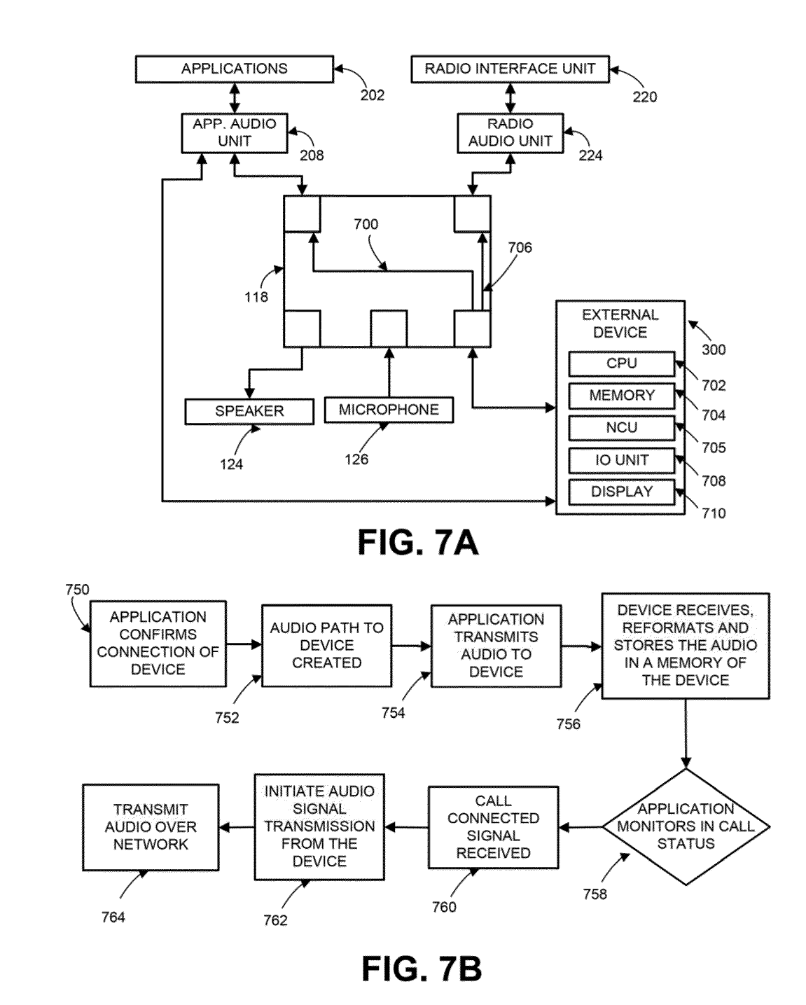

FIG. 7A is a schematic representation of the mobile device 100 connected to an external device 300 that transmits a prerecorded audio signal over a wireless network. The external device 300 may be configured to receive audio signals from the application 202 via the application audio unit 208 over the audio path 700. The external device 300 includes a CPU 702, a memory 704 and a network connection unit 705. The external device is configured to receive an audio signal from the application 202, reformat the audio signal into a format accepted by the radio audio unit 224, and transmit the reformatted audio signal to the radio audio unit 224 via the audio path 706. The audio signal may be stored in the memory 704 of the external device 300 for later transmission.

The application 202 may be communicatively coupled to the external device 300, via the network connection unit 705, using a wireless communication protocol such as Bluetooth. The application 202 may also be communicatively coupled to the external device by a wired data bus, such as a universal serial bus (USB) connection, in the external device 300 and in the mobile device 100. The application 202 may also be communicatively coupled to the external device 300 by a network connection, such as a TCP/IP connection or Ethernet connection. The application 202 may also be connected to the external device 300 by a cradle that includes a serial or USB connection to the external device, the cradle being configured to hold the mobile communication device 100 in a predefined position. The application 202 may also be connected to the external device 300 by an audio adapter on the external device 300 that is configured to engage an audio port on the mobile communication device 100.

FIG. 7B is a schematic representation of a process to transmit an audio signal from an external device 300 over a wireless network though the mobile communication device 100. When the external device 300 is connected to the mobile device 100, the application 202 requests an audio channel 700 between the external device 300 and the application 202 from the audio switch unit 118 via the application audio unit 208, in step 750. The external device 300 may be communicatively coupled to the mobile communication device 100 using a wireless protocol such as Bluetooth, or by a connector coupled to one end of the external device 300. In step 752, the audio switch unit 118 opens the audio path 700 in response to a request from the application audio unit 208. In step 754, the application 202 transmits the audio signal to the external device 300 via the audio path 700. The external device 300 receives the audio signal, coverts the audio signal in to a format accepted by the radio audio unit 224, and stores the audio signal in the memory 704 in step 756.

After the external device 300 stores the audio file, the application 202 monitors the status of the radio interface device 220 via the telephony unit 206 in step 758. When the radio interface unit 220 transmits an “IN CALL” status to the telephony unit 206, the application 202 transmits an “ACCEPT CALL” flag to the radio interface unit 220, causing the radio interface unit 220 to connect the call via the driver unit 226 in step 760.

In step 762, the application 202 transmits a “START TRANSMISSION” signal to the external device 300 via an established wireless connection or hard wire connection between the external device 300 as previously discussed. In step 764, the external device 300 transmits the stored audio signal to the radio audio unit 224 via the audio path 706. The radio audio unit 224 filters the audio signal before sending the audio signal to the wireless network via the radio interface unit 220 and the driver unit 226. While the example above indicates that the application is operating in the mobile communication device 100, the application may also operate on the external device 300.

The external device 300 may include a plurality of switches coupled to an input/output unit 708 in the external device. An application operating in the memory 704 of the external device 300 monitors the status of each switch, and changes the operation of the external device 300 based on the status of the switches. As an illustrative example, when a first switch is selected, the application may transmit audio signals received from the mobile communication device 100 to a head set coupled to the external device 300. When a second switch is selected the application may initiate an auto answer mode where the external device 300 transmits audio signals stored in the memory 704 of the external device 300 over the wireless network via the mobile communication device 100. When a third switch is selected, the application may initiate a call conversion mode where audio signals received by the external device 300 are analyzed by an application operating in the memory 704 of the external device 300. When a fourth switch is selected, the application may receive audio signals transmitted from a microphone coupled to the external device 300, convert the audio signals into a digital format, and store the audio signals in the memory 704 of the external device 300. The switches may be push buttons. Further, the application may also initiate different modes based on the engagement of a combination of switch.

The external device 300 may also include a display unit 710. The display unit 710 may be configured to display a menu that allows users to select different modes of operation for the external device 300. The display unit 710 may also be configured to display information pertaining to the external device 300 and the files stored in the memory 704 of the external device 300. As an illustrative example, the display unit 710 may display a list of recordings stored in the memory 704 of the external device 300. The display unit 710 may be logically coupled to at least one of the switches such that the selection of a switch will correspond to an action described on the display unit 710. As another illustrative example, the selection of a switch may allow a user to listen to a specific audio file stored in the memory 704 of the external device 300. The display unit 710 may also display information pertaining to the association of the audio files stored in the memory 704 to different operational modes of the external device 300.

In the call conversion mode, audio signals received from the wireless network, or from the microphone coupled to the external device 300, are converted into text using conventional voice recognition software algorithms that are widely known in the art. Examples of voice recognition applications include Dragon Naturally Speaking and Microsoft's Text to Speech. The external device 300 may analyze the converted audio signal for keywords, and initiate different modes based on the identified keywords. The user of the mobile communication device 100 may store a list of keywords, and associated operating modes, in the memory 704 of the external device 300.

As an illustrative example, the external device 300 may receive an audio signal that includes the word “emergency.” A user of the mobile communication device 100 may previously configure the external device 300 to automatically notify the user of the mobile communication device 100 of any received audio signal including the word “emergency” by playing an audio tone on the speaker of the mobile communication device 100. Further, the external device 300 may be configured to enter a vehicle mode when an audio signal is received which includes the phrase “mobile device is docked in a vehicle.” The external device 300 may also be configured to initiate any other operational mode based on a keyword previously identified a user of the mobile communication device 100.

FIG. 5A depicts an external device 800 that is configured to transmit an audio signal over a wireless network. The external device 800 includes a microphone input 802, a right speaker output 804, a left speaker output 806, a send/end input 808, and a control unit 810. The control unit 810 may also be provided separate from the speakers 804, 806 and microphone 810. The control unit 810 is communicatively coupled to the audio switch unit 118. The control unit 810 may be coupled to the audio switch unit 118 by an audio adapter, a wireless communication unit, or by any other audio connection. When a call is received, the audio switch unit 118 opens an audio path between the control unit 810 and the application audio unit 208 using any of the methods previously described. The control unit 810 is configured to receive the audio signal and transmit a control signal to the application audio unit 208 based on the operational mode of the external device 800.

In a first mode, when the switch 812 is engaged, the control unit 810 transmits a control signal to the application audio unit 208 by the audio switch unit 118 via audio path 700. The application audio unit 208 receives the control signal, opens an audio path to the radio interface unit 220, and transmits an audio signal stored in the memory 114 of the mobile communication device 100 using any of the previously discussed methods. When the switch is not engaged, the control unit 810 passes the audio signal to the right speaker output 804 and the left speaker output 806. The control unit 810 also transmits audio signals from the microphone 802 to the mobile communication device 100.

The external device 800 may also be a docking, station in a car that allows a user to mount and charge mobile communication device 100. The external device 800 is configured to identify when a mobile communication device 100 is engaged with the docking. When the mobile communication device 100 is docked in the docking station, the control unit 810 transmits a control signal to the application audio unit 208 to transmit audio signals from the memory 114 of the mobile communication unit 100 in response to a received call.

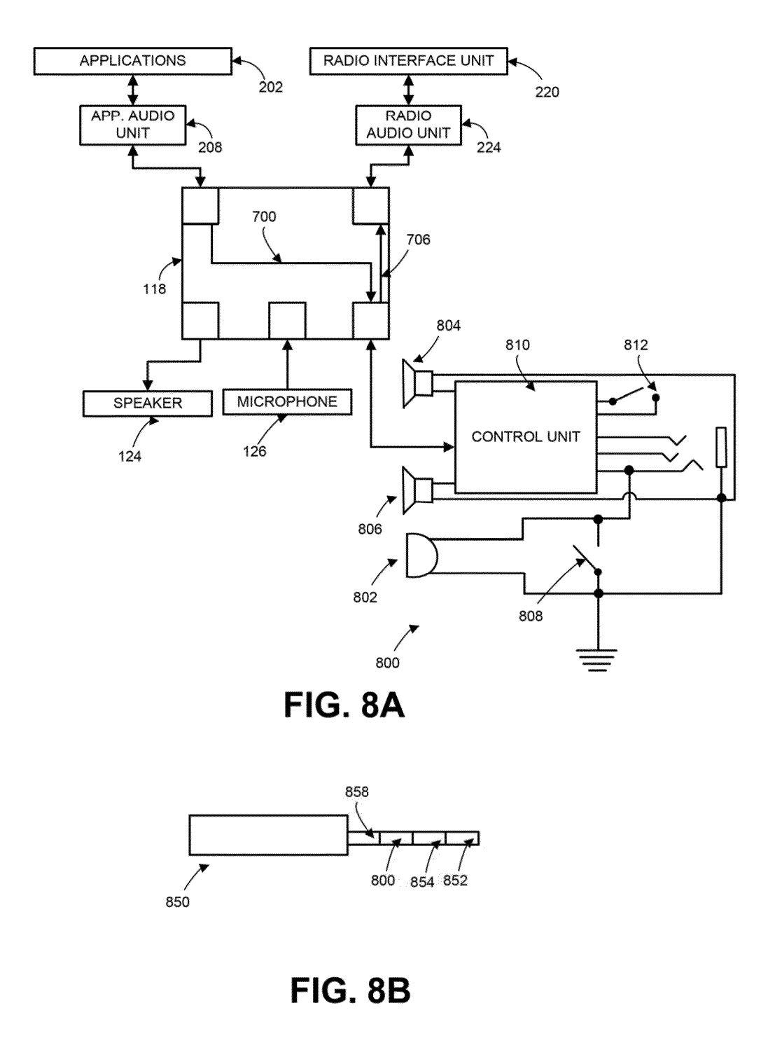

FIG. 8B depicts a connection unit 850 for the external device 800. The connection unit 850 includes a left speaker connector 852, a right speaker connector 854, a common electrical connector 856, and a microphone/call-end connector 858. The left speaker connector 852 receives an audio signal from the audio switch unit 118 that is transmitted to the left speaker. The right speaker connector 854 receives an audio signal from the audio switch unit 118 that is transmitted to the right speaker. The microphone call-end connector 858 transmits an audio signal captured by a microphone to the audio switch unit 118.

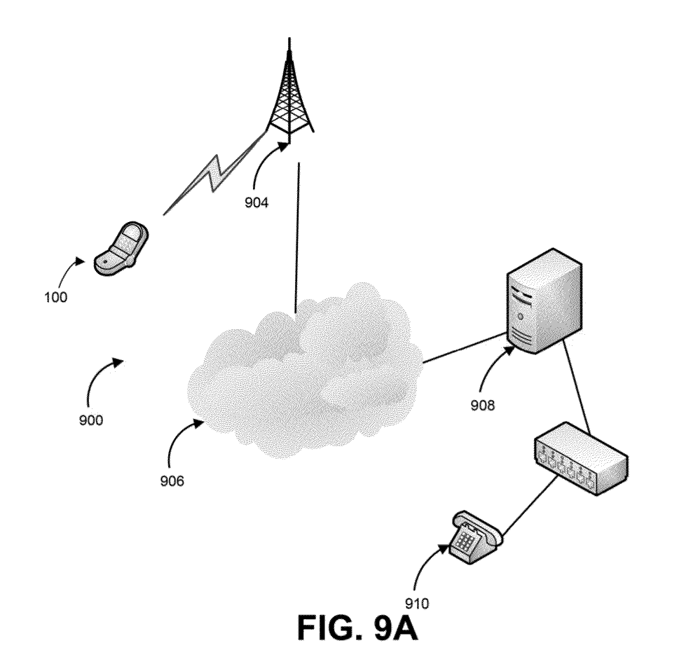

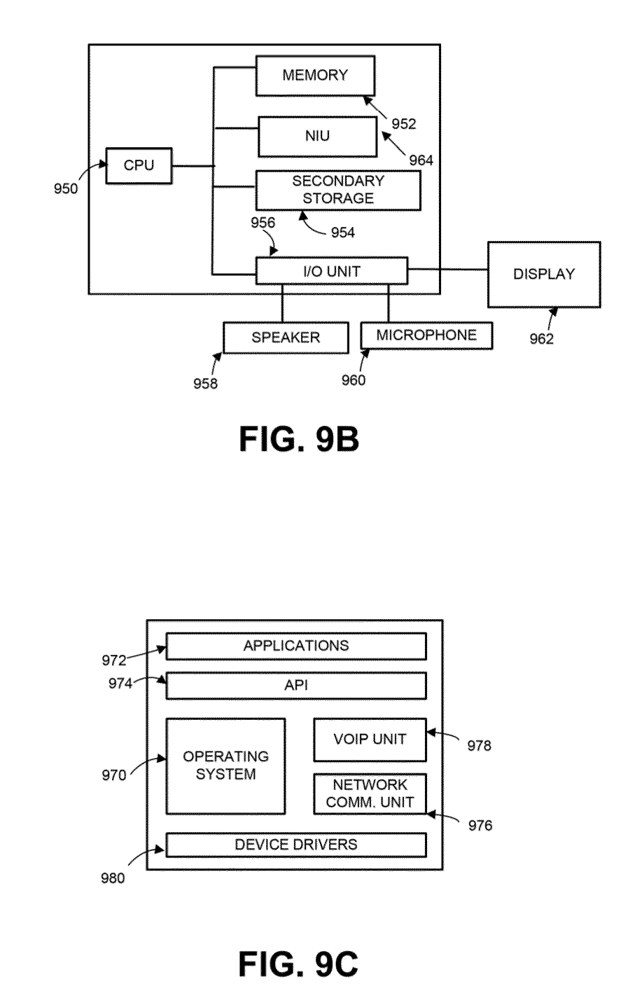

FIG. 9A illustrates a schematic representation of a cellular network communicating with a VOIP network. The network 900 includes a mobile communication device 100, a cellular tower 904 connected to a Wide Area Network (“WAN”) 906, a server 908 connected to the WAN 906, and a second communication device 910 connected to the server 908. The second communication device 910 may be a VOIP phone, a conventional land-line phone, a second mobile communication device, or a computer operating communication software. The mobile communication device 100 communicates with the tower 904 to connect to the second communication device 910 via the WAN 906, Audio signals are transmitted between the mobile communication device 100 and the second communication device 910 via the tower 904 and the WAN 906. When a call is placed between the mobile communication device 100 and the second communication device 910, the mobile communication device 100 communicates with the tower 904 to establish a communication channel between the mobile communication device 100 and the second communication device 910. Once the communication channel is established, communications are initiated between the mobile communication device 100 and the second communication device 910 over the communication channel.

FIG. 9B illustrates a schematic representation of a second communication device 910. The second communication device 910 includes a central processing unit (CPU) 950, a memory 952, a secondary storage unit 954, an input output (IO) unit 956. The IO unit 956 is connected to a speaker 958, microphone 960 and a display 962. The second communication device 910 also includes a Network Interface Unit (NW) 964 that is configured to communicate across a network 906. The network 906 may be a wireless or wired network that communicates using any known communication protocol including TCP/IP, code division multiple access (CDMA), global system for mobile communications (GSM), and universal mobile telecommunications system (UMTS), Short Message Service (SMS), Multimedia Messaging Service (MMS), Long Term Evolution (LTE) or any other cellular communication protocol. The NIU 964 may also communicate over different networks including satellite networks, 3G cellular network's, 4G cellular networks, WIMAX networks, TCP/IP network's, the Internet or any other communications network.

FIG. 9C is a schematic illustration of the software operating on the second communication device 910. The second communication device 910 includes an operating system such as Microsoft Windows. Apple IOS, a proprietary VOW operating system or any other operating system. The second communication device 910 includes an operating system 970 running in the CPU 950. The operating system 970 controls the operation of the CPU 950, memory 952, NIU 964, secondary storage unit 954 and the IO unit 956. An application 972 operating in the operating system 970 interacts with different components of the second communication device 910, such as the display 120, speaker 124, and microphone 126, via an application programming interface (API) 974.

The application 972 communicates over a network by a network communication unit 976 and a VOW unit 978. The you) unit 978 converts audio, video and data signals into a format that is recognizable to mobile communication devices 100 and other VOIP phones or software. The VOW unit 978 may be configured to convert an audio signal received from the speaker 958 and microphone 960 into a VOIP network protocol such as Simple initiation Protocol (SIP), H.248 Protocol, H.323 Protocol or any other VOIP protocol. The application 972 and operating API 974 encapsulate the converted audio signal for transmission over a network via, the network communication unit 976. Video and data information may be transmitted via the VOIP unit 978 and network unit 976. Control of the NIU 964 and other hardware is provided by device drivers 980 logically coupled to the operating system 970.

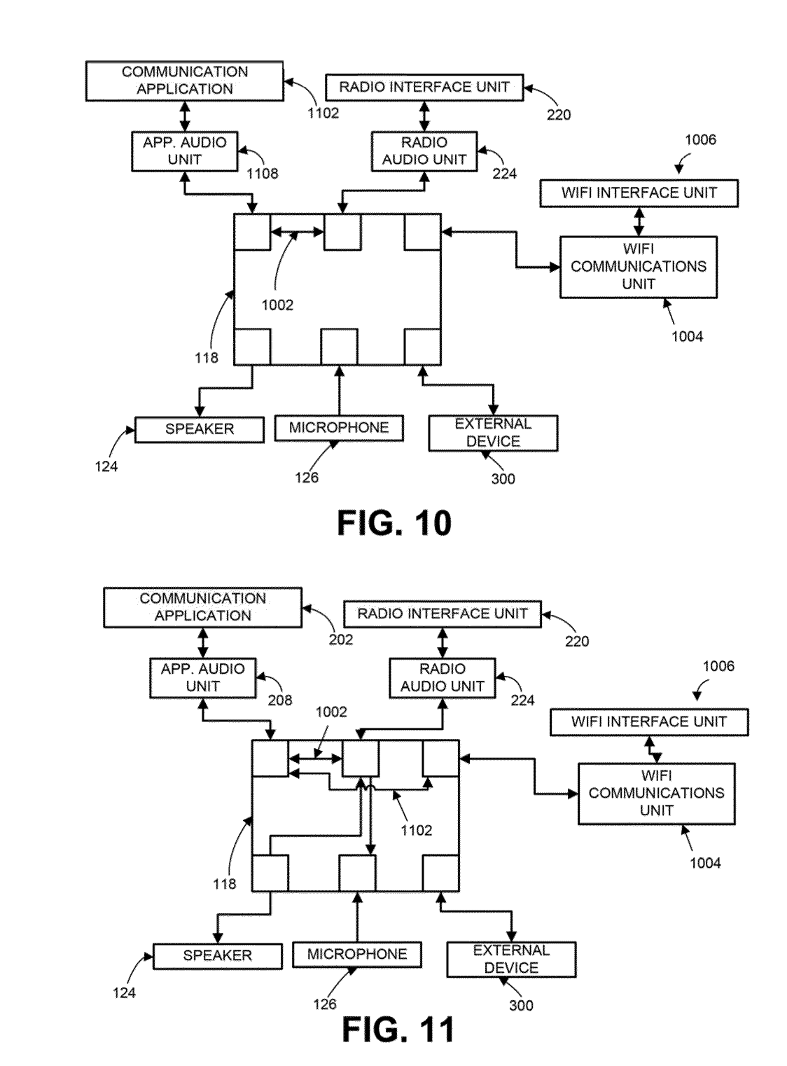

FIG. 10 illustrates the audio switch unit 118 with a communication path. 1002 opened between the application audio unit 208 and radio audio unit 224. The audio switch 118 includes a WiFi communication unit 1004 and a WiFi interface unit 1006. The WiFi communication unit 1004 may be an antenna capable of communicating over an IEEE 802.11 wireless network. The WiFi communication unit 1004 registers with the wireless network using know connection protocols including, but not limited to, TCP/IP. Once a connection is established, the WiFi communication unit 1004 receives and transmits information via the WiFi interface unit 1006. The WiFi communication unit 1004 is communicatively coupled to the audio switch unit 118 such that the audio switch unit 118 may redirect information received from the WiFi communication unit 1004 to the application audio unit 208.

FIG. 11 depicts the audio switch unit 118 on the mobile communication device 100 with a communication path 1002 opened between the application audio unit 208 and radio audio unit 224, and the path 1102 opened between the application audio unit 208 and the WiFi communication unit 1004. With the communication path 1102 open between the application audio unit 208, the application 202 can transmit onto a Win network and receive information from the WiFi network. In addition, the path 1002 allows the application audio unit 208 to receive and transmit signals across the radio network by the radio audio unit 224. The paths 1002 and 1102 can be simultaneously opened such that the application 202 can simultaneously receive information and transmit information across each communication path 1002 and 1102.

To initiate a bridging mode on the mobile communication device 100, a user may select a button on the Graphical User interface (“GUT”) displayed on the mobile communication device 100. In the bridging mode, the application 202 receives communication signals from the radio interface unit 224 via communication connection 1002 and re-routes the communication signals to a predetermined address over a second network via the communication connection 1102. The user may manually identify the network where the address exists by entering the address into the GUI. As an illustrative example, the user may enter a VOW phone number of a second communication device 910 and then select a button on the GUI indicating that the address is a VOIP phone number. In another embodiment, the application 202 searches the WiFi network to identify the address where the second device is located. Once the device associated with the address is located, the application 202 may determine the type of device that is associated with the address by transmitting an identification request to a second application operating on the identified device.

As another illustrative example, a user may initiate a bridge mode on the mobile communication device 100 and the mobile communication device 100 may receive routing address information from the user. Alternatively, the application 202 may automatically select a routing address from a list of predetermined routing addresses. The routing address may be a TCP/IP address on a network, a cellular phone number, a VOW phone number, a conventional land-line telephone number, or any other address capable of receiving a communication signal. The routing address may include information on the network the second communication device 910 is connected to, the geographical location of the second communication device 910 or any other information to assist in establishing a communication connection with the second communication device 910.

In one embodiment, a user selects a button on the GUI to place the mobile communication device 100 into a bridging mode. After the button is selected, the application 202 prompts the user to enter a routing address, such as a second phone number. After the routing address is received, the application 202 transmits a communication request to the application 972 on the second communication device 910 associated with the routing address. The application 972 responds to the connection request with information to create the communication path between the two devices. The application 202 then connects to the second communication device 910 via the communication path 1102 and the application 972. When the communication connection is established between the two applications 202 and 972, the application 202 disconnects the microphone 126 and speaker 124 from the radio audio unit 224 and connects the microphone 125 and speaker 124 to the application audio unit 208 and the application 202 begins routing signals received from the application 972 via the network to the speaker and transmitting signals received from the microphone 126 to the application 972 via the network over the communication path 1102.

The application 202 may display a status indicator on the GUI representing the status of the connection between the mobile communication device 100 and the second communication device 910. The status indicator allows the user to determine if the second communication device 910 or first communication device 972 are connected, available for connection or if the network connection between the two meets minimum data transmission values. As an illustrative example, the application 202 may display the word “CONNECTED” on the GUI to indicate that the two devices 100 and 910 are communicatively connected. In another embodiment, the applications 202 and 972 may insert timing information into an initial connection request to determine the length of time required to transmit information over the network. When the length of time is below a predetermined value, the application 202 may display an icon indicating the connection quality is below the minimum required value. The application 202 or 972 may also perform any other known network analytics to determine the quality of the network connection.

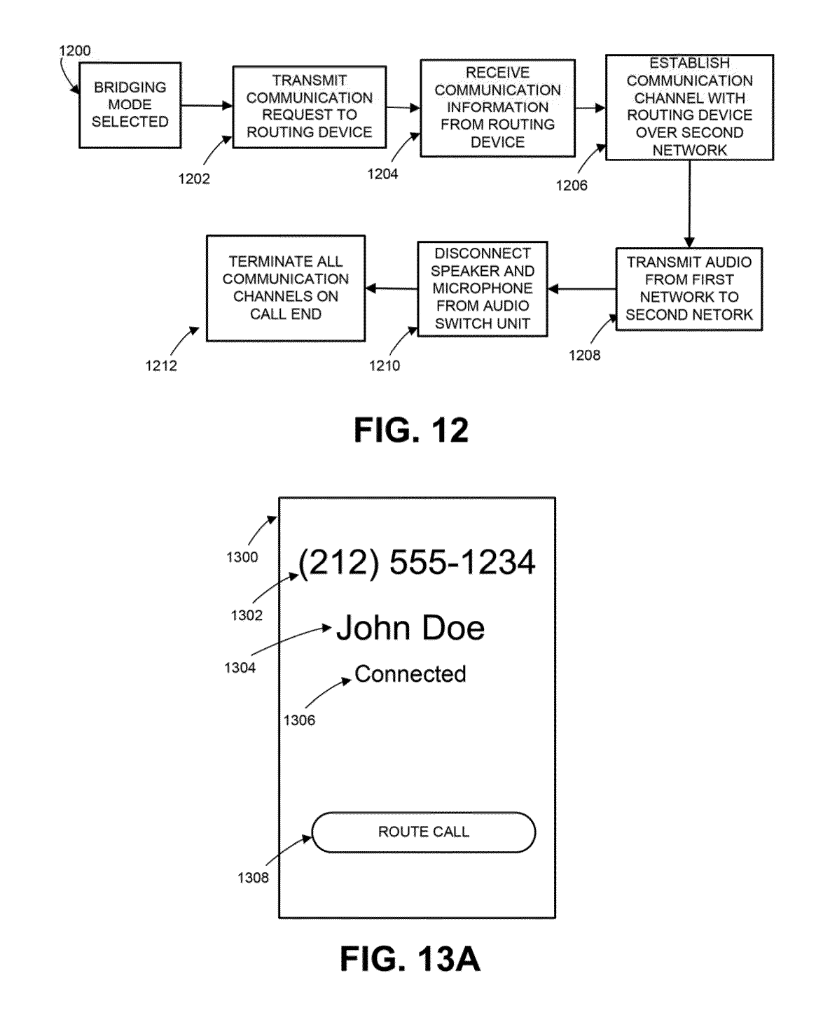

FIG. 12 illustrates a method of bridging a communication connection from a first network to a second network using a mobile communication device 100. In step 1200, a mobile communication device 100 is placed into a bridging mode and the communication device 100 gathers the address of the second communication device 910. In step 1202, the application 202 operating in the mobile communication device 100 transmits a communication request to the application 972 operating on the second communication device 910. The communication request may include information for establishing a two way audio communication with the mobile communication device 100 over a second network. The second network may be a wireless network connected to the mobile communication device 100 and the second communication device 910.

In step 1204, the application 972 operating on the second communication device 910 receives the communication request from the mobile communication device 100, and transmits communication connection information to the mobile communication device 100. The communication connection information may include detailed information on the communication connection between the two devices including encryption information, such as hash keys, network address information, communication protocol information such as SIP communication protocol information, connection speeds, or any other information required for the two devices to communicate over the second network. In step 1206, the application 202 and the application 972 establish a communication connection over the second network.

In step 1208, the application 202 reconfigures the audio switch unit 118 to route signals from the radio audio unit 224 to the application 202 over connection 1002 while maintaining a connection between the mobile communicating device 100 and the transmitting device. The application 202 then configures each audio signal to comply with the communication protocol of the second communication device 910. As an illustrative example, the application 202 may receive digital audio signals from the radio audio unit 224, and may convert the audio signals to an H.323 VOIP communication packet which is routed to the wireless network via the audio switch unit 118. The application 972 on the second communication device 910 receives the H.323 communication packet and processes the information as a standard VOIP phone call.

In step 1210, once communication with the second communication device 910 is established, the application 202 disconnects the speaker 126 and microphone IN from the audio switch unit 118. Communication with the second communication device 910 may be established by selecting a connect button on a GUI displayed on the display 962 of the second communication device 9110. By pressing the connect button, the second communication device 910 completes the audio connection with the mobile communication device 100 and initiates two way communication with the mobile communication device 100. In another embodiment, picking up a receiver, or turning on a speaker on the second communication device 910 may initiate the transfer of communications on the mobile communication device 100. Consistent with this embodiment, the second communication device 910 may transmit a signal to the mobile communication device 100 that that the speaker 958 on the second communication device 910 is on. In step 1212, the application 202 monitors the communication with the second communication device 910 and terminates any connections via the radio audio unit 224 or the WiFi communication unit 1004 when the call is terminated.

While FIG. 12 depicts a mobile communication device 100 connecting, to a second communication device 910 and establishing a communication channel, the second communication device 910 may also initiate a communication channel with the mobile communication device 100. Consistent with this embodiment, the second communication device 910 establishes a connection with the mobile communication device 100 via the application 972 operating on the second communication device 910. The application 972 disconnects the speaker 958 and microphone 960 while maintaining the connection with the transmitting device in the same manner as the mobile communication device 100.

In another embodiment, the mobile communication device 100, or the second communication device 910, may receive additional communication requests while bridging communications from one network to another network. The mobile communication device 100, or the second communication device 910, may be configured to incorporate additional communications from into the bridged communication into a single conference call communication. Consistent with this embodiment, the application 202 or 972 on the bridging device 100 or 910 receives an incoming communication request and prompts the user of the bridging device 100 or 910 to accept or reject the call. If the user accepts the call, the application 202 or 972 running on the bridging device 100 or 910 asks the user whether to place the call on hold or merge the call, if the user merges the call, the application 202 or 972 establishes a connection with the new device or devices and routes the communications together with the previously established communications. If the user places the call on hold, the application 202 or 972 opens a connection with the new device using any of the previously discussed methods and routes the new connection to the mobile communication device 100, or the second communication device 910 using any of the methods discussed herein.

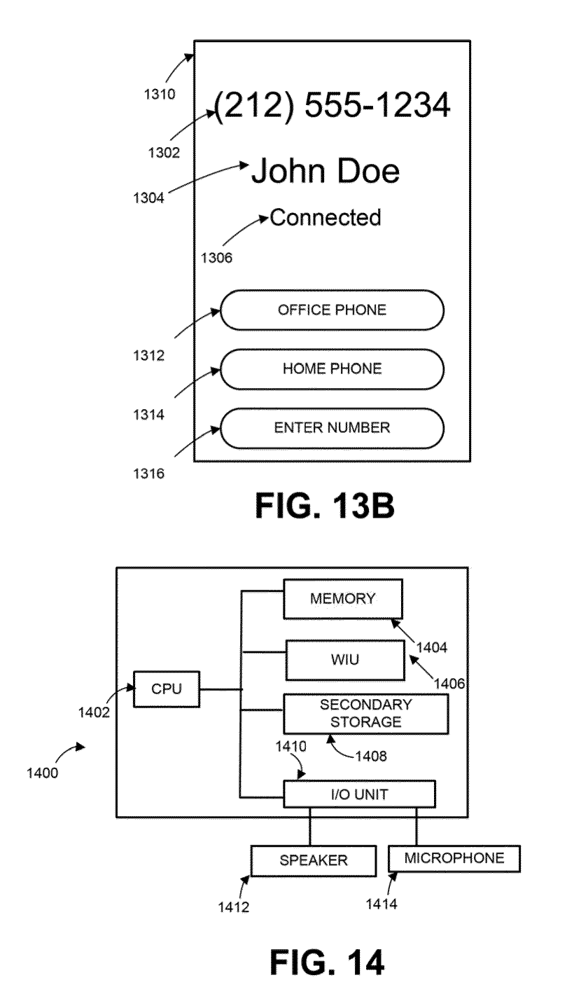

FIG. 13A illustrates a GUI 1300 displayed on a display 120 of the mobile communication device 100. The GUI 1300 displays the phone number 1302 and an identifier 1304 of the call currently connected to the mobile communication device 100. A status indicator 1306 displays the status of the connection between the mobile communication device 100 and the second communication device 972. A button 1308 is positioned on the lower portion of the GUI 1300 that allows the user to re-route the call currently connected to a second communication device 910.

FIG. 13B illustrates a GUI 1310 that is displayed after a user selects the button 1306. The GUI 1310 includes two buttons 1312 and 1314 that display predefined second communication devices 910 where the connected call may re-routed. As an illustrative example, depressing the “OFFICE PHONE” button will cause the application 202 to connect to the predefined address associated with the “OFFICE PHONE” in the application 202. Further, the application 202 stores the communication protocol, network addresses, and other communication information in the memory 114 of the mobile communication device 100 such that the application 202 can connected to the second communication device 910 associated with the button 1312. Alternatively, by selecting button 1316, a user may enter a new phone number that causes the application 202 to send a communication request to the new phone number using standard VOIP communication requests.

The second communication device 910 may also include a display that allows the user to initiate the re-routing of a call connected to the mobile communication device 100. When the user selects the button, the second communication device 910 transmits a signal to the mobile communication device 100 instructing the mobile communication device 100 to complete the re-routing of the call. In an alternate embodiment, the application 202 may complete the re-routing when the user picks up the receiver or opens an audio communication path on the second communication device 910.

FIG. 14 depicts an external device 1400 that may be used to bridge calls on a communication device. The external device 1400 may be a wireless telephone headset configured to connect to as mobile communication device 100 or VOIP phone via a wireless communication protocol, such as BlueTooth. The external device includes a Central Processing Unit (“CPU”) 1402, a memory 1404, a wireless interface unit (“WIU”) 1406, a secondary storage unit 1408, and an input/output unit (“IO unit”) 1410. A speaker 1412 and microphone 1414 may be connected to the IO unit 1410.

The external device 1400 may be configured to transmit and receive audio signals with a mobile communication device 100 or a second communication device 972 via the WIU 1406. The WIU 1406 may allow the device to simultaneously connect to a mobile communication device 100 or a second communication device 972 using two different wireless connections. Connecting using two separate wireless connections is widely known in the art and can be achieved using communication protocols such as Bluetooth or IEEE 802.11. When connected to the communication device 100 or 910, one connection may receive audio signals from a third communication device communicatively coupled to the communication device 100 or 910 over a cellular network or wireless network. The second connection may be communicatively coupled to the application 202 or 972 on the mobile communication device 100 or the second communication device 910. As the external device 1400 receives communication signals from the mobile communication device 100 or second communication device 910, the external device 1400 converts the communication signals to a predetermined format and transmits them to the application 202 or 972 via the second wireless connection. The application 202 or 972 then transmits the re-transmitted signals to a third communication device communicatively coupled to the application 202 or 972 using any of the previously described methods.

The application 202 or 972 also forwards communication signals received from the third communication device to the external device 1400 where the received communication signals are transmitted to the mobile communication device 100 or second communication device 972. In this way, the external device 1400 acts as the audio switch unit 118 to bridge communications between two communications networks. Accordingly, the external device 1400 is capable of performing the same function as the audio switching unit 118. The external device 1400 may also bridge text messages, video signals, data or any other information that is transmitted over a cellular network or wireless network

As an illustrative example, a wireless Blue headset may be connected to the mobile communication unit 100 by a first wireless connection and a second wireless connection. The first wireless connection may be communicatively coupled to the application 202 via the application audio unit 208, and the second wireless connection may be communicatively coupled to the radio audio unit 224. When the external device 1400 connects to the application 202, the application transmits communication conversion information detailing how the communication signal is to be transmitted to the application 202.

When the mobile communication device 100 establishes a communication channel with a third communication device such as a mobile communication device, communication signals from the third communication device are muted through the radio audio unit 224 via the audio switching unit 118 to the external device. The external device 1400 receives the communication signal and converts the signal into the format defined by the application 202. The external device 1400 then transmits the converted communication signal to the application 202. The application 202 then transmits the communication signal to a second communication device 972. Communication signals from the second communication device 972 are transmitted to the external device 1400 from the application 202, converted to a format that is transmittable over the radio audio unit 224, and sent to the radio audio unit 224 via the audio switch unit 118 for transmission to the third communication device.

As one having ordinary skill in the art would recognize, by bridging calls from one network to another, a user can transfer a call from one device to another without disconnecting and reconnecting a call. Further, a user has the option of re-routing a call from a static line to a mobile device to allow the user to move freely while continuing a conversation without terminating and reinitiating a call.

In the present disclosure, the words “a” or “an” are to be taken to include both the singular and the plural. Conversely, any reference to plural items shall, where appropriate, include the singular.

It is to be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

1. A communication bridging device having a processor and a memory, the communication device including:
an application unit operating an application that transmits and receives communication signals to a first communication device over a first wireless network;
a wireless interface unit that transmits and receives communication signals to a second communication device over a second wireless network;
a switching unit communicatively coupled to the application unit and the wireless interface unit,
wherein, the switching unit transmits communication signals between the first network and the second network in a bridging mode, the application unit transmits communication signals from the switching unit to the first communication device, over the first wireless network in the bridging mode, and the wireless interface unit transmits communication signals from the switching unit to the second communication device over the second wireless network in the bridging mode.

2. The bridging device of claim 1, wherein the first wireless network is the internet and the second wireless network is a cellular network.

3. The bridging device of claim 1 including a display unit coupled to an input Output unit in the bridging device.

4. The bridging device of claim 3, wherein an operational mode is adjusted by a graphical user interface shown on the display.

5. The bridging device of claim 1, wherein the communication signal is an audio signal.

6. The bridging device of claim 1, wherein the communication signal is a text message.

7. The bridging device of claim 1, wherein the communication signal is a data signal.

8. The bridging device of claim 1, wherein the first communication device is a voice over internee protocol phone and the second communication device is a cellular phone.

9. The bridging, device of claim 1, wherein the application simultaneously transmits and receives communication signals for the first communication device and a fourth communication device communicatively coupled to the first wireless network.

10. A method of bridging a communication signal across two networks using a communication device having a memory and a processor, with an program executing in the memory that executes the steps of:
connecting to a first communication device over a first network by an application unit;
connecting, simultaneously, to a second communication device over a second network by a wireless interface unit;
receiving a first communication signal from the first communication device by the application unit;
transmitting the first communication signal from the first device to the second network by a switching unit coupled to the application unit and the wireless interface unit.

11. The method of claim 10, including the steps of
receiving a second communication signal from the second communication device, and
transmitting the second communication signal from the second communication device to the first communication device by the switching unit.

12. The method of claim 10, including the step of displaying a graphical user interface on a display unit coupled to an input output unit in the device, where the graphical user interface allows a user to change an operational mode of the device.

13. The method of claim 10, wherein the communication signal is an audio signal.

14. The method of claim 10, wherein the communication signal is a text message.

15. The method of claim 10, wherein the communication signal is a data signal.

16. The method of claim 10, wherein the first communication device is a voice over internet protocol phone and the second communication device is a cellular phone.

17. The method of claim 10 including the step of simultaneously transmitting and receiving communication signals for the first communication device and a fourth communication device communicatively coupled to the first wireless network.

18. A wireless communication device having a memory and a processor, comprising:
a wireless interface unit simultaneously connected to a radio communication unit in a first communication device by a first wireless network and to an application unit in the first communication device by a second wireless network;
an application unit communicatively coupled to the first network and second network by the wireless interface unit,
wherein the application unit receives a first communication signal from a radio application unit in the first communication device over the first network and transmits the communication signal to the application unit by the second network, and wherein the application unit transmits the first communication signal to a second communication device by a third wireless network coupled to the first communication device.

19. The device of claim 18 wherein the application unit receives a second communication signal from an application processing unit in the first communication device, and wherein the application unit transmits the second communication signal to the radio application unit in the first communication device via the first network.

20. The device of claim 20 including a speaker and a microphone communicatively coupled to the application unit.
